(19) United States
(12) Patent Application Publication
(10) Pub. No.: US 2025/0100134 A1
(43) Pub. Date: Mar. 27, 2025

(54) ROBOT CONTROL DEVICE, ROBOT CONTROL SYSTEM, ROBOT, AND ROBOT CONTROL METHOD

(71) Applicant: Hitachi, Ltd., Tokyo (JP)

(72) Inventors: Hiroshi ITO, Tokyo (JP); Hideyuki ICHIWARA, Tokyo (JP)

(21) Appl. No.: 18/883,338

(22) Filed: Sep. 12, 2024

(30) Foreign Application Priority Data
Sep. 26, 2023 (JP) 2023-163721

(51) Int. Cl. B25J 9/16; B25J 13/08

(52) U.S. Cl. CPC B25J 9/163; B25J 13/089

(57) ABSTRACT

Provided is a robot control device that can learn an autonomous motion and an autonomous recovery motion at the same time on the basis of robot sensor information. The robot control device includes a reverse data generation device that uses forward data as measured robot sensor time series information to generate reverse data as the reverse time series data of the forward data, a feature amount error calculation unit that learns the feature amounts of the forward data and the reverse data to infer the association relationship between a forward direction and a reverse direction, a machine learning device that infers robot motions in the forward direction and the reverse direction on the basis of robot sensor information, and an instruction unit that outputs the instruction value of the machine learning device to a robot.

### CLAIM OF PRIORITY

The present application claims priority from Japanese Patent application serial no. 2023-163721, filed on Sep. 26, 2023, the content of which is hereby incorporated by reference into this application.

### BACKGROUND

The present invention relates to a technique that is effective to be applied to a robot control device, a robot control system, a robot, and a robot control method that use machine learning to autonomously execute a recovery motion.

Unlike a limited environment that is environment improved for a robot, such as a factory, the living environment of a human requires highly specialized knowledge and huge developing cost for modeling a surrounding environment, a target to be operated, and a robot itself. To solve this problem, the application of machine learning to the robot is being advanced, and it is expected that sensor information measured in the real world is caused to be learned to acquire recognition and a motion generation model at the same time without precisely building an environment model. By the machine learning, it is possible to acquire, at saved cost, a single motion, such as the gripping of an object in a complicated shape, a fitting work that is required to control a force and a finger tip position at the same time, and moving in various environments, which are difficult to achieve in the conventional technique.

However, since the machine learning is not versatile, in order to respond to an unpredicted situation, it is necessary to previously comprehensively study an abnormal state for implementing a suitable exceptional process and a fault tolerant design. Consequently, the huge developing cost is still caused. In addition, the robot system is designed on the assumption that when the abnormality of the sensor is detected during the operation of the robot system, the production line and the robot are stopped and the human enters the site to remove the error factor, so that the lowering of the operating rate and the sustainment of the robot system is a problem.

Accordingly, when the robot can use the machine learning to learn and execute the motion necessary for the error recovery from the robot itself and the surrounding environment information, the reduction in the developing cost and the improvement in the operating rate of the robot can be expected. However, in the data driving type robot system using the machine learning, a huge amount of data is caused to be learned to acquire the motion flexible for the environment (forward direction inference), and on the other hand, a systematic method for achieving the recovery motion has not been proposed.

As the background art of the present technical field, for example, there is a technique like Japanese Unexamined Patent Application Publication No. 2022-63707. Japanese Unexamined Patent Application Publication No. 2022-63707 discloses a configuration in which with respect to an abnormal state caused in an autonomous work robot, a robot system is instructed to generate a self-support motion by using a learned model acquired by machine learning or to perform a previously set recovery motion (autonomous recovery motion), thereby reducing support by an operator.

In addition, “Mike Schuster and Kuldip K. Paliwal. “Bidirectional recurrent neural networks.” IEEE Transactions On Signal Processing VOL. 45, NO. 11 (1997): 2673-2681” discloses a technique that is a type of a machine learning algorithm that can infer a forward direction and a reverse direction, and improves the prediction precision of a model by taking not only past time series information but also future time series information into consideration.

### SUMMARY

In Japanese Unexamined Patent Application Publication No. 2022-63707, the support information such as the remote operation by the operator is learned to acquire the self-support motion. Consequently, to acquire the self-support motion generation model, the motion teaching cost and the model learning cost are caused.

In addition, in “Mike Schuster and Kuldip K. Paliwal. “Bidirectional recurrent neural networks.” IEEE Transactions On Signal Processing VOL. 45, NO. 11 (1997): 2673-2681”, it is necessary to input both of the past and future time series information. However, it is difficult to apply this technique since the robot cannot acquire the future information.

Accordingly, an object of the present invention is to provide a robot control device, a robot control system, a robot, and a robot control method that can learn or generate an autonomous motion and an autonomous recovery motion at the same time on the basis of robot sensor information.

To solve the above problems, the present invention provides a robot control device including a reverse data generation device that uses forward data as measured robot sensor time series information to generate reverse data as the reverse time series data of the forward data, a feature amount error calculation unit that learns the feature amounts of the forward data and the reverse data to infer the association relationship between a forward direction and a reverse direction, a machine learning device that infers robot motions in the forward direction and the reverse direction on the basis of robot sensor information, and an instruction unit that outputs the instruction value of the machine learning device to a robot.

In addition, the present invention provides a robot control system including a robot, and a robot control device that controls the robot. The robot includes a measurement unit that measures an external environment to transmit the measurement result to the robot control device, and a driving unit that is driven on the basis of an instruction value outputted from the robot control device. The robot control device includes a forward data accumulation unit that accumulates forward data as robot sensor time series information measured by the measurement unit, a reverse data generation device that uses the forward data to generate reverse data as the reverse time series data of the forward data, a forward and reverse data accumulation unit that associates the relationship between the forward data and the reverse data to store the associated relationship, a feature amount error calculation unit that learns the feature amounts of the forward data and the reverse data to infer the association relationship between a forward direction and a reverse direction, a machine learning device that infers robot motions in the forward direction and the reverse direction on the basis of robot sensor information, and an instruction unit that outputs the instruction value of the machine learning device to the robot.

In addition, the present invention provides a robot control method having (a) a step of reading a machine learning model defined by a user, (b) a step of using the machine learning model read in the (a) step and previously accumulated learning data to learn the optimal parameter of the machine learning model according to a target function, (c) a step of acquiring robot sensor information, and (d) a step of using the machine learning model learned in the (b) step and the robot sensor information acquired in the (c) step to predict a motion instruction value. In the (d) step, the forward direction inference and the reverse direction inference of robot motions are performed.

According to the present invention, it is possible to achieve the robot control device, the robot control system, the robot, and the robot control method that can learn the autonomous motion and the autonomous recovery motion at the same time on the basis of the robot sensor information.

This can contribute to the reduction in the developing cost and the improvement in the operating rate of the robot.

Objects, configurations, and effects other than the above will be apparent from the description of the following embodiments.

### BRIEF DESCRIPTION OF THE DRAWINGS

FIG. 1 is a diagram illustrating the schematic configuration of a robot system according to a first embodiment of the present invention;

FIG. 2 is a diagram schematically illustrating the processing contents of a reverse data generation device of FIG. 1;

FIG. 3 is a diagram schematically illustrating the calculation method of a feature amount error calculation unit of FIG. 1 and internal expressions acquired by the same;

FIG. 4 is a flowchart illustrating a robot control method according to the first embodiment of the present invention;

FIG. 5 is a diagram illustrating an autonomous recovery motion example based on sensor information;

FIG. 6 is a diagram illustrating an autonomous recovery motion example based on confidence degree information according to a second embodiment of the present invention;

FIG. 7 is a diagram illustrating an autonomous recovery motion example based on a language instruction according to a third embodiment of the present invention; and

FIG. 8 is a diagram illustrating the judgement example of salience according to the embodiments of the present invention by robot behavior.

### DESCRIPTION OF EMBODIMENTS

A robot control device according to an embodiment of the present invention includes a reverse data generation device that generates at least one reverse time series data (reverse data) from at least one piece of measured robot sensor time series information (forward data), a feature amount error calculation unit that learns the feature amounts of the forward data and the reverse data to be able to infer a forward direction and a reverse direction, a machine learning device that learns at least one or more motions to be able to autonomously infer the forward direction and the reverse direction on the basis of the robot sensor time series information, and an instruction unit that outputs the instruction value of the machine learning device to a robot.

Three features of the robot control device according to the present embodiment will be described below.

The first point is that the present robot control device generates the reverse data from the learning data (the forward data) for performing a target work. Both of the forward data and the reverse data are caused to be learned, so that the motions in the forward direction (the same motion as the forward data) and the reverse direction (the motion that reversely reproduces the forward data) can be generated (inferred) on the basis of the sensor information. The reverse direction inference is used at the occurrence of an abnormality, so that the simple autonomous recovery motion like the motion “returning to the past particular state” can be generated. This can suppress the cost for collecting the data necessary for the learning. It is not necessary to learn a huge amount of data, and the data collection cost and the model learning cost can be suppressed.

The next point is that the present robot control device causes one model to learn a plurality of motions, and autonomously switches the motion patterns on the basis of the sensor information. With this, when changing to the different motion that has been learned in the past is performed, it is possible to eliminate the necessity to previously teach the plurality of motions for causing the model to learn the motions, and further, when a plurality of models are switched at the occurrence of an abnormality, it is possible to eliminate the necessity to additionally implement a state change model and the like therefor. That is, it is possible to reduce the model learning cost and to eliminate the necessity to implement the state change model.

The last point is that the present robot control device includes the feature amount error calculation unit that learns the feature amounts of the forward and reverse data to be able to infer the forward direction and the reverse direction. With this, the model inference directions (the forward direction and the reverse direction) and the motion patterns can be switched on the basis of an abnormal state and an instruction by a human, thereby generating the autonomous recovery motion.

The terms of the robot control device according to the present embodiment will be described below.

The sensor data is the measurement value of the sensor that measures the state of each driving unit (actuator) of the robot, or the measurement value of the sensor that is mounted outside the robot and measures the surrounding situation. Examples of the measurement value of the sensor that measures the state of each driving unit include a joint angle, an electric current value, a torque value, a tactile value, a camera image, and the like. Examples of the sensor that measures the surrounding situation include a camera, a motion capture, and the like.

The forward data are a series of sensor data when an arbitrary motion teaching method is used to teach a target motion to the robot. The forward data are represented in time series. The forward data represented in time series include data that are measured at a plurality of times and in which the respective measurement values at the plurality of times are associated with each other.

The reverse data are data in which the time series order of the previously collected forward data is reversed (inverted). For example, when the time series data of an image are stored as the forward data, the data obtained by reversely reproducing the forward data become the reverse data.

The machine learning model has a mechanism that derives a result (=output) with respect to input data. In the case of the robot, the machine learning model has a mechanism that predicts a motion instruction value (result) on the basis of the sensor information (input data), and can take various methodologies for a specific model structure. The model of the present invention does not depend on a particular machine learning model, such as Recurrent Neural Network, Transformer, and Convolutional Neural Network. Note that in the present invention, the machine learning model, the motion generation model, and the model have the same meaning.

The autonomous recovery motion includes at least one or more of the following three motions. The first one is to retry the work in order to achieve the target motion (hereinafter, recovery motion 1). The second one is to perform changing to the different motion that has been learned in the past (hereinafter, recovery motion 2). The third one is to perform returning from the present state to the past particular state (hereinafter, recovery motion 3). Specifically, the forward direction inference predicts the motion instruction value for performing the target motion, whereas the reverse direction inference predicts the motion instruction so as to return from an arbitrary state to the initial state. With this, when an abnormal state is caused during the forward direction inference, the reverse direction inference is used to be able to return to the arbitrary state. In the recovery motions 1 and 2, the robot autonomously performs the recovery motion on the basis of the sensor information, whereas in the recovery motion 3, the state change is enabled on the basis of the automatic return to the previously set state or the instruction by the human.

Hereinbelow, embodiments of the present invention will be described with reference to the drawings. Note that the same configurations in the respective drawings are indicated by the same reference numerals, and the detailed description of the overlapped portions is omitted.

### First Embodiment

### (The Configuration of the Robot Control Device)

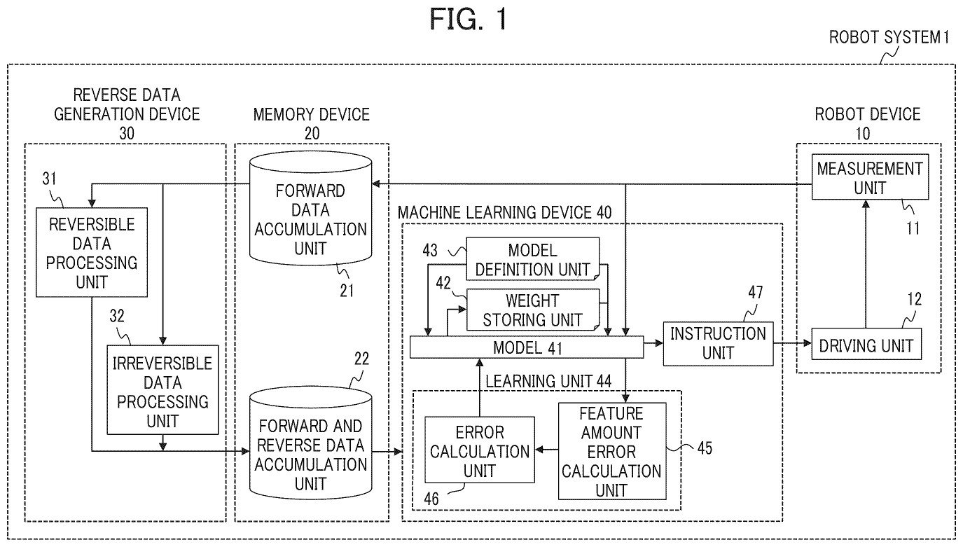

The robot control device and the robot control method according to a first embodiment of the present invention will be described with reference to FIGS. 1 to 5.

FIG. 1 is a diagram illustrating the configuration example of a robot system 1 including a reverse data generation device 30 and a feature amount error calculation unit 45 according to the present embodiment. In the present embodiment, the arbitrary motion teaching method such as teleoperation is used to teach the desired motion to a robot device 10, robot sensor time series information measured at that time is accumulated into a forward data accumulation unit 21, and the reverse data generated by the reverse data generation device 30 and the forward data accumulated in the forward data accumulation unit 21 are used to learn a machine learning device 40. The motion teaching is a work that teaches the target motion to the robot, and records the sensor data of the robot at a constant sampling rate. Examples of the representative method of the motion teaching include programming description that uses a programming language to previously describe and execute the motion, direct teaching in which the human grabs and moves the robot in a torque free state or a self-weight compensation mode, the teleoperation using a 3D mouse, a VR (Virtual Reality), a haptics device, a remote operation device of the same and different configuration, and the like, and the like. Hereinafter, the processing contents of each device and the generation method of the autonomous motion will be described.

### (Robot Configuration)

The robot device 10 can be configured of, for example, a multi-joint robot and the like. A measurement unit 11 of the robot device 10 measures the sensor value of the information of the sensor mounted on the robot, a joint angle, torque information, an RGB color image, a depth image (distance image), a monochrome image, and the like. A driving unit 12 of the robot device 10 changes the angle of each joint to generate the motion. The manipulator may be driven by an electric motor, or may be driven by the actuator operated by a fluid pressure, such as an oil pressure and an air pressure. The driving unit 12 is driven according to the motion instruction information outputted from an information processing device. In addition, the driving unit 12 is not limited to the multi-joint robot, and may be a movable machine that enables numerical control (NC).

### (Memory Device)

The robot system 1 includes a memory device 20 having the forward data accumulation unit 21 that stores the robot sensor time series information (forward data), and a forward and reverse data accumulation unit 22 that associates the relationship between the forward data and the reverse time series data (reverse data) with each other to store the associated relationship.

### (Reverse Data Generation Method)

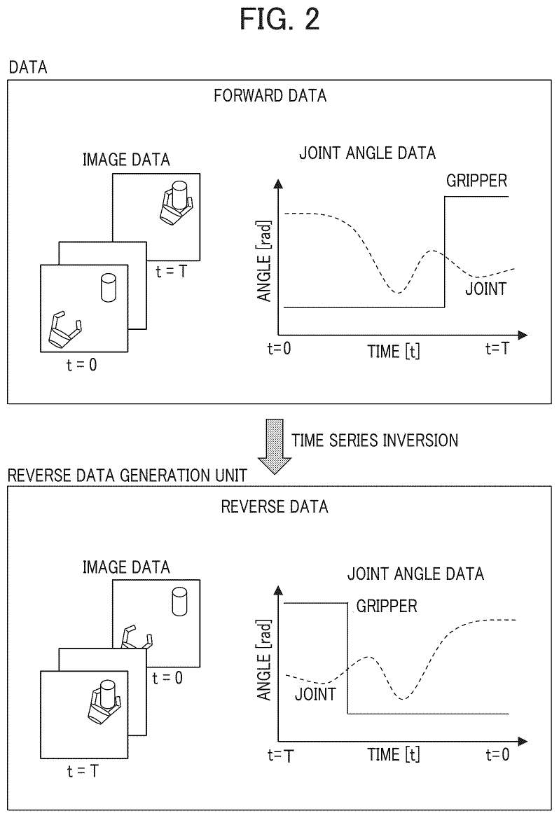

In the present embodiment, the reverse data generation device 30 changes the reverse data generation processing method according to reversible data and irreversible data among the previously collected sensor information (the camera, the joint angle, the torque information, the contact information, and the like). FIG. 2 illustrates an example of the reverse data generated from the forward data, in which in order that the association between the forward data and the reverse data is caused to be learned, the feature amount error calculation unit 45 associates the relationship between the forward data and the reverse data to store the associated relationship in the forward and reverse data accumulation unit 22.

Here, the reversible data is information without a time characteristic, like the image and the joint angle, and is information that can replace the time series order. The inspection method of the reversible data generates reverse data A generated by replacing the time series order of previously collected forward data A, for example, forward data B generated by temporarily storing the images, the joint angles, and the like measured when the joint angles are applied to the robot and replacing their time series order. At this time, the information in which a large difference in value between the original forward data A and the forward data B generated by the reverse data is not caused is the reversible data. Note that it is necessary to note that due to the subtle noise caused in the real world, the forward data and the reverse data do not have exactly the same value.

On the other hand, the irreversible data is information having a hysteresis characteristic, like the torque information and the tactile information, and is information that cannot simply replace the time series order. As the inspection method of the irreversible data, like the reversible data, the value of the original forward data A and the value of the forward data B generated by the reverse data are compared with each other, and the information having a different characteristic is the irreversible data. For example, the torque information depends on an environment such as a gravity direction, a moving direction, and a speed and the past input.

In the present invention, a reversible data processing unit 31 replaces the time series order of the reversible data to generate the reverse data. An irreversible data processing unit 32 applies a linearization process, a smoothing process, and the like to the irreversible data, and then replaces the time series order to generate the reverse data. By performing the process such as the smoothing, the irreversible data is converted to the reversible data in a pseudo manner.

Note that for example, the robot system 1 of the present embodiment illustrated in FIG. 1 can be achieved by a hardware configuration by a central processing unit (CPU) and a recording device, such as a memory, a hard disk, and a solid state drive (SSD). In this case, each function of the reverse data generation device 30 and the machine learning device 40 is achieved by interpreting and executing a program installed in the CPU, and the function of the memory device 20 is achieved by the recording device such as the memory.

In addition, the memory device 20 may be disposed at a position spaced from the reverse data generation device 30 and the machine learning device 40, and be connected to the reverse data generation device 30, the machine learning device 40, and the robot device 10 via a computer network such as the Internet.

In addition, although FIG. 1 illustrates the configuration example in which the feature amount error calculation unit 45 and an instruction unit 47 are included in the machine learning device 40, they may be respectively disposed to be independent from the machine learning device 40.

### (Model Learning Method 1)

In the present embodiment, the machine learning device 40 uses a model definition unit 43 in which the structure of the model previously designated by a user is defined and the learning data accumulated in the forward and reverse data accumulation unit 22 to calculate (learn) the optimal parameter of a model 41 by a learning unit 44 according to a target function. The optimal parameter acquired by the learning is stored in a weight storing unit 42 of the machine learning device 40.

Note that the user can set an arbitrary function to the target function used by an error calculation unit 46 of the learning unit 44 according to purpose, and a mean squared error and the like are given. In the present embodiment, the parameter of the model configuring the machine learning device 40 is optimized such that the motion instruction value of the robot device 10 at time t+1 is predicted from various sensor information at time t.

The input/output time and the time width can be arbitrarily set. Specifically, the motion instruction value at time t+10 can be predicted from the sensor information at time t, and the motion instruction value at particular time or the motion instruction values at a plurality of times (t+1, t+2, t+3) can be predicted from the sensor information at a plurality of times (t−2, t−1, t).

The instruction unit 47 inputs the predicted motion instruction value to the driving unit 12 of the robot device 10, and can thus generate the motion on the basis of the predicted instruction value.

### (Model Learning Method 2)

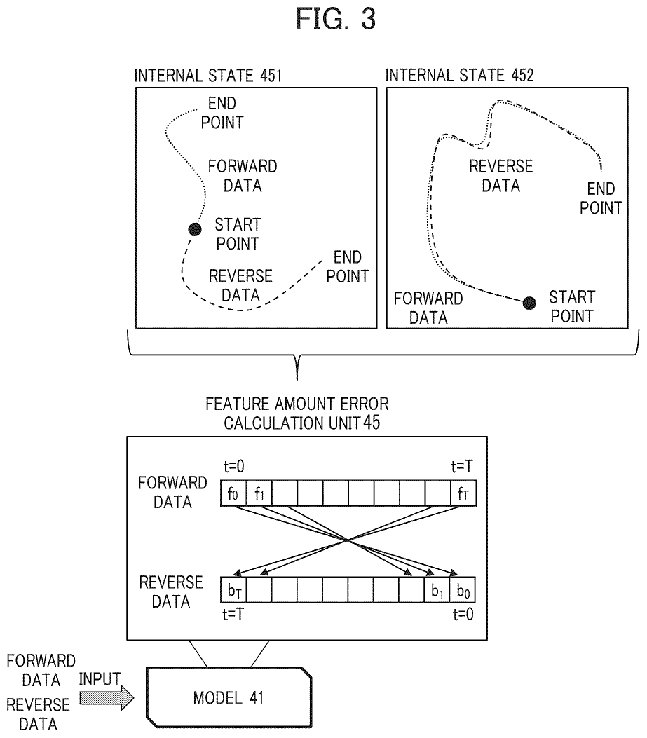

In the present embodiment, the feature amount error calculation unit 45 performs the association learning of the internal expressions of the forward data and the reverse data. FIG. 3 is a diagram representing the calculation method of the feature amount error calculation unit 45 and the internal expressions acquired by the same. A pair of the forward data and the reverse data stored in the forward and reverse data accumulation unit 22 is taken out, and is inputted to the model 41 to perform the learning.

When the typical machine learning is performed, the forward data and the reverse data are learned as data having totally different characteristics, so that the features as represented by an internal state 451 are formed in a self-organization manner inside the model. Consequently, although the motion of each of the forward data and the reverse data can be generated from the start point toward the end point, it is difficult to generate the reverse direction motion by using the feature of the reverse data during the generation of the forward direction motion.

Accordingly, the present inventors have devised the new addition of an error function that associates the internal expressions of the forward data and the reverse data with each other. Specifically, the error function is newly set such that the distance between the feature amount (f0, f1, . . . fT) of the forward data and the feature amount (b0, b1, . . . bT) of the reverse data extracted inside the model is small.

The mean squared error or the like is used to cause the model to perform the learning such that the distance between the feature amounts of the forward data and the reverse data is small, so that the features as represented by an internal state 452 are formed inside the model in a self-organization manner. Since the features of the forward data and the reverse data are close to each other, it becomes easy to generate the reverse direction motion by using the feature of the reverse data during the generation of the forward direction motion. In the present invention, by using the feature amounts, the autonomous recovery motion is generated.

Note that the error function set by the feature amount error calculation unit 45 is added to the error function defined by the model learning method 1, thereby optimizing (learning) the model 41 as one error function.

### (Motion Generation Flow)

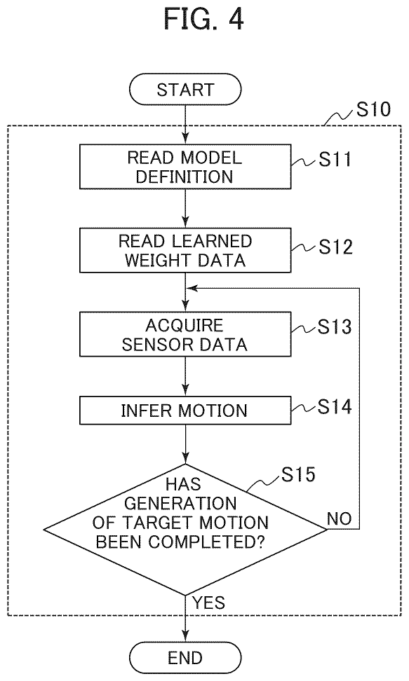

Hereinbelow, the motion generation flow S10 of the robot system 1 will be described with reference to FIG. 4. In the process of FIG. 4, by using the machine learning device 40, the sensor information measured by the measurement unit 11 is inputted to the model 41 to predict the instruction value, which is then transmitted to the driving unit 12 via the instruction unit 47. The robot device 10 sequentially generates the motion so as to achieve the target motion. Hereinbelow, the overall flow will be described.

When the process is started, first, in step S11, the machine learning model defined by the user is read from the model definition unit 43.

Next, in step S12, various parameters configuring the machine learning model acquired by the motion learning are read from the weight storing unit 42. Next, in step S13, various sensor information measured by the measurement unit 11 is acquired.

Next, in step S14, the motion instruction value is predicted by using various sensor information acquired in step S13 and the machine learning device 40. The predicted motion instruction value is transmitted to the driving unit 12 via the instruction unit 47 to drive the actuator.

Finally, in step S15, it is judged whether or not the target motion can be achieved, and if the target motion is being performed (No), the process returns to step S13. When it is judged that the target motion can be achieved (Yes), the process is ended.

By repeating the above steps, the robot device 10 can sequentially generate the motion on the basis of the sensor information measured by the measurement unit 11 until the target motion is achieved.

### (The Generation of the Autonomous Recovery Motion)

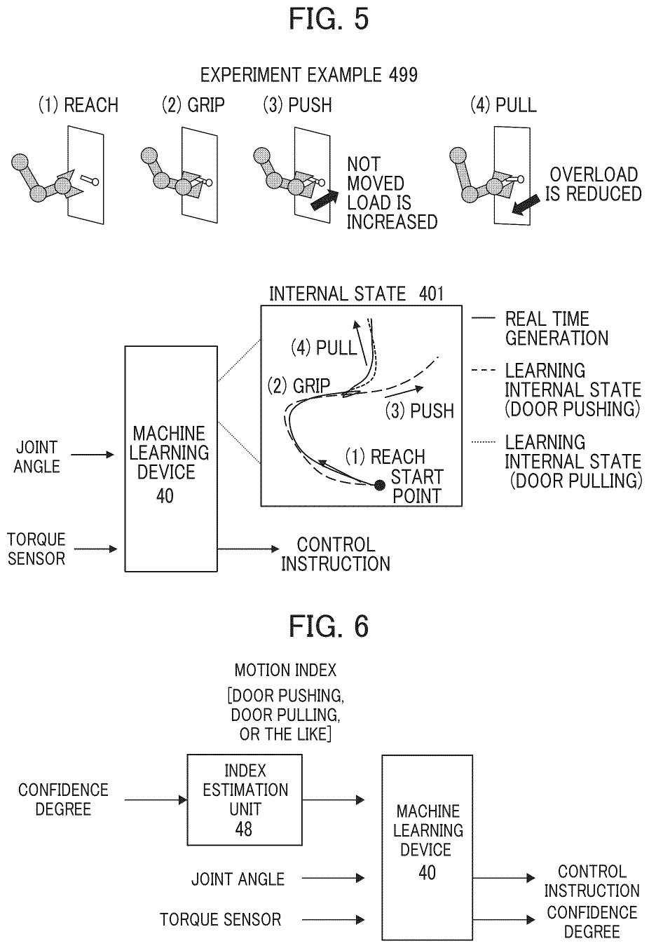

In the present embodiment, the robot is caused to learn a plurality of motion patterns, and autonomously performs the motion switching at the occurrence of an abnormality. FIG. 5 illustrates an autonomous recovery motion example based on the sensor information.

The robot is previously caused to learn the door opening motion of the door pushing and the door pulling configured in three steps ((1) reach, (2) grip, and (3) push or (4) pull), so that as illustrated by an internal state 401, two types (door pushing and door pulling) of features are formed inside the model 41 of the machine learning device 40 in a self-organization manner.

Two types (door pushing and door pulling) of features having different motions are originally formed like the internal state 451 of FIG. 3, but by using the feature amount error calculation unit 45 of the present invention, the internal state of the shared work ((1) reach and (2) grip) draws the similar trajectory.

On the other hand, since the motions of the (3) push and the (4) pull are different, the internal state is branched. Here, the robot is caused to perform the forward direction inference in an environment in which it cannot be visually judged whether the door pushing is performed or the door pulling is performed. The forward direction inference is to predict the action yt+1 to be taken at the next time t+1 on the basis of the sensor information xt at the certain time t. This corresponds to the prediction of the near future state and its instruction value from the present state. The robot can reach and grip the door knob, but even when thereafter, the robot pushes the door knob, the door is not opened, so that the load information measured by the torque sensor is increased to detect the abnormal state. At this time, as indicated by the thick line of the internal state 401, the robot can return to the branch point by performing the reverse direction inference, and can autonomously execute the recovery motion by executing the motion of the (4) pull. The reverse direction inference is to predict, in a reverse manner, the action yt−1 to be taken at the previous time t−1 on the basis of the sensor information xt at the certain time t. This corresponds to the prediction of the state of the previous time and its instruction value from the present state.

The switching from the forward direction inference to the reverse direction inference and the switching from the motion of the (3) push to the motion of the (4) pull are automatically performed inside the model. For example, in the Recurrent Neutral Network, the action change such that the error is minimum (a state where an abnormal state is unlikely to be caused) by the entrainment function peculiar to the model is automatically performed, so that by using this function, the inference and motion switching is achieved.

When an abnormal state is caused, the typical robot system is required to return to the initial position to reperform the work, so that the work efficiency is lowered. On the other hand, in the present invention, when an abnormality is detected, the recovery motion can be immediately generated without returning to the initial position, so that it can be expected that the operating rate of the robot is improved.

By the above embodiment, it is possible to execute the autonomous motion based on the past learning experience and to execute the autonomous recovery motion at the time of an abnormality. The past learning experience is a feature that is formed inside the model in a self-organization manner when the machine learning model is caused to perform the learning by using the previously collected forward data, the reverse data, or both data. For example, when the abstract expression of the learning data is learned inside the model to cause the robot motion to be learned, the motion patterns such as “push, take, and pull” are stored as the features. At the time of the generation of the robot motion, the motion pattern acquired at the time of the learning is finely adjusted on the basis of the present sensor information to generate the motion suitable for the situation. Since the internal state of the model is high dimension information, the feature (motion pattern) of the internal state can be visualized by using a dimensional compression method such as main component analysis.

Further, by the above embodiment, while the model is typically caused to learn only the forward data, the learning of the reverse data is added, thereby obtaining the following three effects.

(1) The forward data and the reverse data are caused to be learned to make it possible to learn the time series relationship (the time series order and the timewise before/after relationship) of the data more emphasizingly, so that even when disturbance and the change in lighting are caused, the motion having robustness and high accuracy can be generated (inferred).

(2) When the forward data in which a state where the partial sensor data is missing (deviation value) or an object in the field of vision is shielded (occlusion) is caused to be learned, the time series data is abruptly changed, or the target object is shielded, so that the learning by the model becomes unstable. Such an abnormal state is complemented by using the forward data and the reverse data to cause the model to perform the learning, and as a result, the stable learning can be performed.

(3) Even when during the autonomous work by the robot, the occlusion is caused, or the noise and missing are caused in the partial sensor data, the stable inference is enabled.

### Second Embodiment

The robot control device and the robot control method according to a second embodiment of the present invention will be described with reference to FIG. 6.

### (System Configuration)

FIG. 6 is a diagram illustrating the configuration example of the machine learning device 40 including an index estimation unit 48 that outputs the confidence degree of the work by the robot and estimates a motion index on the basis of the confidence degree according to the present embodiment. If two types (door pushing and door pulling) of motions are taught to the robot, the machine learning device 40 is caused to perform the learning by using, in addition to the robot information, the motion index. This makes it possible to learn (store) the motion for each index, and the index of the motion to be executed is inputted to the model 41 at the time of the generation of the motion, so that the robot can be caused to execute the desired motion pattern.

For example, the door opening motion index of the door pushing type is 0, and the door opening motion index of the door pulling type is 1, thereby causing the machine learning device 40 to perform the learning, so that by inputting 0 to the motion index at the time of the inference, the door opening motion of the door pushing type is generated. For the motion index, in addition to the numerical value, language information, and the like previously defined by the human, the numerical value of the index can also be determined by the learning.

### (The Generation of the Autonomous Recovery Motion According to the Confidence Degree)

The confidence degree according to the present embodiment is an index representing the certainty of the predicted value, and is achieved by various implementation methods. As an example, the average and the distribution of a joint angle trajectory are considered. When the information transmitted to the driving unit 12 via the instruction unit 47 of the machine learning device 40 is the joint angle of the robot, the machine learning device 40 predicts, as the control instruction, the average of the joint angles, and predicts, as the confidence degree, the distribution of the joint angle. With a situation close to the learning environment, the robot can predict the motion instruction value in which the predicted distribution is small. On the other hand, when the confidence degree is low, the predicted distribution of the robot becomes large. The present function can be achieved by using a probability model that can calculate the average and the distribution.

When the confidence degree (predicted distribution) predicted by the model is below (above) the particular threshold value, the index estimation unit 48 performs the switching to the suitable motion index, and can thus execute the autonomous recovery motion. As the actual machine application example, for example, an operator inputs the door pushing index to the model by mistake, and the robot executes the motion on the basis of the sensor information. However, since the actual door is the pulling door, the door cannot be opened after the door knob is gripped. At this time, since the confidence degree outputted by the model is reduced (the predicted distribution becomes large), when the distribution value is above the predetermined threshold value, the index estimation unit 48 performs the switching to the door pulling motion, so that the robot can immediately perform the motion switching. The motion switching can be immediately performed without returning to the initial position, so that also in the present embodiment, likewise, it can be expected that the robot operating rate is improved.

### Third Embodiment

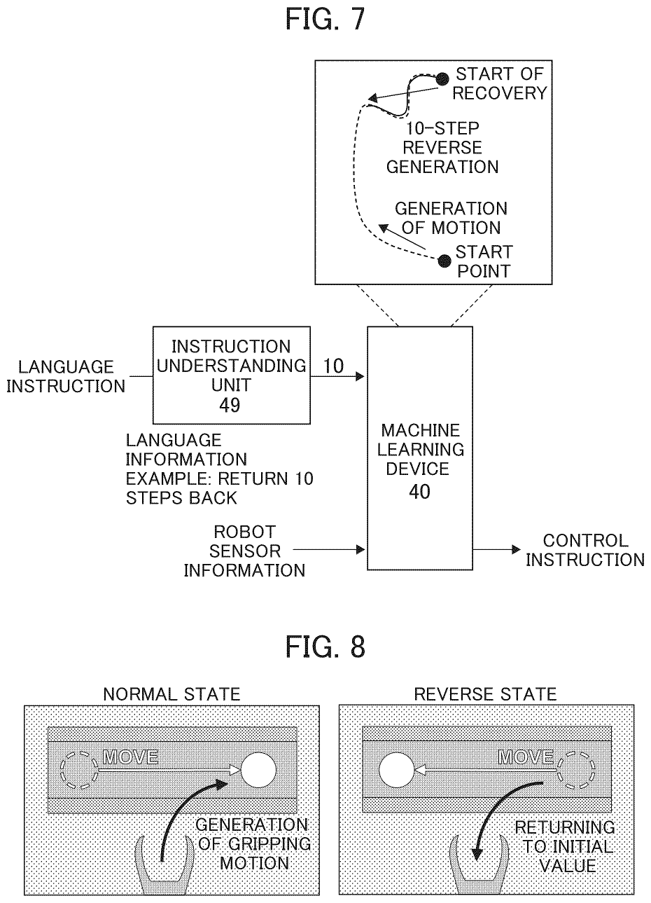

The robot control device and the robot control method according to a third embodiment of the present invention will be described with reference to FIG. 7.

### (System Configuration)

FIG. 7 is a diagram illustrating the configuration example of the machine learning device 40 including an instruction understanding unit 49 that understands an abstract instruction such as voice and a character according to the present embodiment. In the present embodiment, the step (time) reverse direction inference instructed by the operator is executed with respect to the robot that is performing the forward direction inference. The instruction understanding unit 49 understands the number of steps to be executed from the abstract instruction of the operator, and inputs the value to the machine learning device 40.

With this, when an abnormal state occurs, the machine learning device 40 can be moved to the predetermined position to instruct, from there, the new motion instruction and the retry of the work.

In view of engineering, the past trajectory is stored, and the trajectory is reversely reproduced, so that the machine learning device 40 can be moved to the predetermined position. However, the internal state of the machine learning device 40 cannot be changed (updated) only by the reverse reproduction of the trajectory, so that by performing the reverse direction inference disclosed in the present invention, the reverse reproduction of the trajectory and the update of the internal state can be performed at the same time.

### <<Salience>>

An example of a method of confirming whether or not the present invention is performed will be described below. Note that the method of confirming the salience is not limited to this.

The internal state 451 and the internal state 452 of FIG. 3 are results (an example) obtained by dimension compressing and visualizing the feature of the high dimension (internal state) formed inside the machine learning model by using the main component analysis and the like. When the forward data and the reverse data regarding a certain particular motion are caused to be learned, the internal state 451 is the internal state in the case of not using the present invention, and the different internal states of the forward data and the reverse data are learned. On the other hand, by using the present invention, as represented by the internal state 452, the internal states of the forward data and the reverse data match. For its reason, the learning (the association of the features) is performed by the feature amount error calculation unit 45 such that the internal states of the forward data and the reverse data match.

FIG. 8 illustrates the behavior of the robot with respect to the change in the environment (an example). As illustrated in the left figure, the robot that has learned the gripping of the object on the belt conveyor on which the object is flowed from the left to the right generates the autonomous motion so as to grip the object in the normal state. On the other hand, as illustrated in the right figure, when the advancing direction of the belt conveyor is changed to the reverse direction (from the right to the left), the motion in which the robot returns to the initial position is generated. For its reason, since the state (the advancing direction) of the belt conveyor visually corresponds to the reverse data, the robot generates the motion of the reverse direction inference. Since the behavior of the robot is changed with the change in the environment in this way, the salience can be confirmed.

Note that the present invention is not limited to the above embodiments, and includes various modifications. For example, the above embodiments have been described in detail to simply describe the present invention, and are not necessarily required to include all the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

What is claimed is:

1. A robot control device comprising:
a reverse data generation device that uses forward data as measured robot sensor time series information to generate reverse data as the reverse time series data of the forward data;
a feature amount error calculation unit that learns the feature amounts of the forward data and the reverse data to infer the association relationship between a forward direction and a reverse direction;
a machine learning device that infers robot motions in the forward direction and the reverse direction on the basis of robot sensor information; and
an instruction unit that outputs the instruction value of the machine learning device to a robot.

2. The robot control device according to claim 1,
wherein the machine learning device learns a plurality of motion experiences to autonomously infer the robot motions in the forward direction and the reverse direction without performing a complicated work procedure and replacement.

3. The robot control device according to claim 1,
wherein the reverse data generation device performs the reverse data generation according to each of the characteristics of reversible data and irreversible data into which, on the basis of the characteristic of the forward data including a hysteresis characteristic, the robot sensor time series information is classified.

4. The robot control device according to claim 1,
wherein provided is a forward and reverse data accumulation unit that generates the reverse data from the previously collected forward data, and associates the relationship between the forward data and the reverse data to store the associated relationship.

5. The robot control device according to claim 1,
wherein the feature amount error calculation unit adds a limit to an error function such that the forward data and the reverse data match in an internal state of a model of the machine learning device.

6. The robot control device according to claim 1,
wherein provided is an index estimation unit that outputs the confidence degree of the work of the robot, and estimates a motion index on the basis of the confidence degree.

7. The robot control device according to claim 1,
wherein provided is an instruction understanding unit that understands an abstract instruction including voice and a character.

8. The robot control device according to claim 4,
wherein the machine learning device includes a model definition unit in which the structure of the model previously designated by a user is defined, and
a learning unit that learns the optimal parameter of the model, and
the model definition unit and learning data accumulated in the forward and reverse data accumulation unit are used to learn the optimal parameter of the model by the learning unit according to a target function.

9. The robot control device according to claim 4,
wherein the feature amount error calculation unit takes out a pair of the forward data and the reverse data accumulated in the forward and reverse data accumulation unit, and inputs the pair of the forward data and the reverse data to the model to perform the association learning of the internal expressions of the forward data and the reverse data.

10. A robot control system comprising:
a robot; and
the robot control device according to claim 1,
wherein the robot includes
a measurement unit that measures an external environment to transmit the measurement result to the robot control device, and
a driving unit that is driven on the basis of an instruction value outputted from the robot control device, and
the robot control device includes
a forward data accumulation unit that accumulates forward data as robot sensor time series information measured by the measurement unit,
a forward and reverse data accumulation unit that associates the relationship between the forward data and the reverse data to store the associated relationship.

11. A robot comprising:
the robot control device according to claim 1;
a measurement unit that measures an external environment to transmit the measurement result to the robot control device; and
a driving unit that is driven on the basis of an instruction value outputted from the robot control device,
wherein the robot control device includes
a forward data accumulation unit that accumulates forward data as robot sensor time series information measured by the measurement unit,
a forward and reverse data accumulation unit that associates the relationship between the forward data and the reverse data to store the associated relationship.

12. A robot control method comprising:
(a) a step of reading a machine learning model defined by a user;
(b) a step of using the machine learning model read in the (a) step and previously accumulated learning data to learn the optimal parameter of the machine learning model according to a target function;
(c) a step of acquiring robot sensor information; and
(d) a step of using the machine learning model learned in the (b) step and the robot sensor information acquired in the (c) step to predict a motion instruction value,
wherein in the (d) step, the forward direction inference and the reverse direction inference of robot motions are performed.

13. The robot control method according to claim 12,
wherein in the (b) step, a plurality of motion experiences are learned to perform the forward direction inference and the reverse direction inference.

14. The robot control method according to claim 12,
wherein the learning data in the (b) step includes reverse data as reverse time series data generated according to each of the characteristics of reversible data and irreversible data into which, on the basis of the characteristic of forward data as measured robot sensor time series information including a hysteresis characteristic, the robot sensor time series information is classified.

15. The robot control method according to claim 12,
wherein the learning data in the (b) step is learning data in which the reverse data as the reverse time series data is generated from the forward data as the previously collected robot sensor time series information, the relationship between the forward data and the reverse data is associated, and the associated relationship is stored.
